(19) United States
(12) Patent Application Publication
(10) Pub. No.: US 2023/0367750 A1
(43) Pub. Date: Nov. 16, 2023

(54) SYSTEM AND METHOD FOR ASSIGNING AN ENTITY A UNIQUE IDENTIFIER

(71) Applicant: Noetic Master Model Holding Company LLC., Great Falls, VA (US)

(72) Inventors: Justin MAGRUDER, Great Falls, VA (US); John TALBURT, Little Rock, AR (US); Daniel PULLEN, Little Rock, AR (US); Chris O'NEILL, Denver, CO (US); Stephen SIELOFF, Lake Mary, FL (US)

(21) Appl. No.: 18/029,040

(22) PCT Filed: Sep. 29, 2021
(86) PCT No.: PCT/US2021/052723

§ 371 Date: Mar. 28, 2023

Related U.S. Application Data
(60) Provisional application No. 63/084,943, filed on Sep. 29, 2020.

(51) Int. Cl. G06F 16/22; G06F 16/28; G06F 16/25

(52) U.S. Cl. CPC G06F 16/22; G06F 16/288; G06F 16/252

(57) ABSTRACT

A method of assigning a unique identifier to an entity includes receiving a name of an entity and associated information about the entity; and assigning a globally unique identifier to the entity conforming to both the ISO 8000-115 and the ISO 8000-116 standards The unique identifier includes a domain portion defining a jurisdiction of the entity; a sub-domain portion having an entity type, global registration agency code for the jurisdiction, and a date of registration or formation of the entity; and a registration identifier portion of the entity in the jurisdiction. The method further includes storing the unique identifier along with the name of the entity in a database for fast retrieval of information about the entity.

### CROSS REFERENCE TO RELATED APPLICATIONS

The present application claims priority benefit to provisional patent application No. 63/084,943, filed on Sep. 29, 2020, the entire content of which is incorporated herein by reference.

### BACKGROUND

### 1. Technical Field

The currently claimed embodiments of the present invention relate to computation, and more specifically, to a system and method for assigning an entity a unique identifier and a structure of the unique identifier.

### 2. Introduction

An identifier is a reference to a data set controlled by a managing entity. Identifiers are widely exchanged by governments and commercial companies to refer to data which describes individuals, organizations, locations, goods, services, assets, processes, procedures, laws, rules, and regulations. Some example identifiers can include: vehicle registration number (license plate), driver's license number, social security number, employee number, passport number, tax identification number, IP address, telephone number, email address, domain name, part number, batch number, serial number, customer number, supplier number, concept identifiers, and a particular rule or regulation. Such identifiers can also be used to identify a given legal entity, such as when you see a license plate for a given state, or an email address associated with a business entity operating in a global market.

Currently used identifiers do not provide adequate distinctions between distinct entities, where a single identifier is assigned to two or more distinct entities, or where there are many jurisdictions and each jurisdiction creates its own set of identifiers. As a result, the use of a given identifier, by itself, may create confusion because the entity it is associated with is unknown.

To address this issue, the International Organization for Standardization (ISO) has developed a standard (ISO 8000-116) for creating a single, authoritative legal entity identifier. However, while the ISO 8000-116 standard provides a template and requirements for creating identifiers for legal entities, the standard leaves to the user discretion with respect to certain aspects of the identifier in the application of the standard.

Therefore, there remains a need for an identifier that solves the above and other problems of the prior art by providing a unique and unambiguous identifier for both natural and juridical persons while conforming to the ISO 8000-116 standard.

### SUMMARY

An aspect of the present invention is to provide a method and system for creating a unique and unambiguous identifier for natural and juridical persons conforming to the ISO 8000-116 standard and which identifies the legal entity authorizing the person and the registration number issued by the authorizing entity. In addition, an embodiment of the present invention provides a method and system for creating a “proxy identifier” for cases where the information about the legal entity and registration number authorizing the person are not available, but the person has been registered by a secondary legal entity.

For example, in the United States, the authoritative legal registration of a natural person is a birth certificate issued by a state department of health or vital statistics. An embodiment of the present invention encodes the registration information into a universally unique identifier resolvable to the legal authority of registration as required by the ISO 8000-116 standard. If the birth certificate information for a natural person is not available, but the person is registered with another legal entity, such as a United States passport issued by the US Department of State, then an embodiment of the present invention allows for encoding the passport registration information into a universally unique “proxy identifier” to be replaced by the authoritative legal identifier at such time the birth registration information becomes available.

An aspect of the present invention is to provide a method of assigning a unique identifier to an entity. The method includes receiving a name of an entity and associated information about the entity; assigning a unique identifier to the entity. The unique identifier includes: a domain portion defining a jurisdiction of the entity; a sub-domain portion having an entity type, a global registration agency code for the jurisdiction, and a date of registration or formation of the entity; and a registration identifier portion of the entity in the jurisdiction. The method further includes storing the unique identifier along with the name of the entity in a database for fast retrieval of information about the entity.

In an embodiment, the domain portion complies with ISO 3166-1 and ISO 3166-2 standards. In an embodiment, the jurisdiction of the entity comprises a jurisdiction country of the entity and jurisdiction state or region in the country of the entity. In an embodiment, the jurisdiction country complies with ISO 3166-1 standard and the jurisdiction state or region complies with ISO 3166-2 standard. In an embodiment, the global registration agency code for the jurisdiction comprises a plurality of characters or numbers, or both. In an embodiment, the registration identifier portion includes a plurality of characters or numbers, or both. In an embodiment, the domain portion and the sub-domain portion are separated by a period (“.”), the sub-domain portion and the registration identifier portion are separated by a colon (“:”). In an embodiment, the domain portion and sub-domain portion form a prefix of the unique identifier, and the registration identifier portion forms a suffix of the unique identifier. In an embodiment, the prefix and the suffix of the unique identifier are separated by a colon (“:”) character. In an embodiment, the unique identifier is convertible into a unique hash code. In an embodiment, the unique identifier complies with ISO 8000-116 standard when the entity is a legal entity and has been granted legal status by the governing body of a nation, state, or community. In an embodiment, the unique identifier further includes another portion which includes any one of a metropolitan area, a county, a city, a borough, or a region within a jurisdiction country of the entity.

Another aspect of the present invention is to provide a unique identifier for identifying an entity. The unique identifier includes a domain portion defining a jurisdiction of the entity; a sub-domain portion having an entity type, a global registration agency code for the jurisdiction, and a date of registration or formation of the entity; and a registration identifier portion of the entity in the jurisdiction. The unique identifier along with the name of the entity are stored in a database for fast retrieval of information about the entity.

In an embodiment, the domain portion complies with ISO 3166-1 and ISO 3166-2 standards. In an embodiment, the jurisdiction of the entity comprises a jurisdiction country of the entity and jurisdiction state or region in the country of the entity. In an embodiment, the jurisdiction country complies with ISO 3166-1 certification and the jurisdiction state or region complies with ISO 3166-2 certification. In an embodiment, the entity type comprises a plurality of characters or numbers, or both. In an embodiment, the sub-domain comprises a plurality of characters or numbers, or both, the sub-domain being unique within the domain portion. In an embodiment, the domain portion and the sub-domain portion are separated by a period (“.”), and the sub-domain portion and the registration identifier portion are separated by a colon (“:”). In an embodiment, the domain portion and sub-domain portion form a prefix of the unique identifier, and the registration identifier portion forms a suffix of the unique identifier. In an embodiment, the unique identifier is convertible into a unique hash code. In an embodiment, the unique identifier complies with the ISO 8000-116 standard when the entity is a legal entity and has been granted legal status by the governing body of a nation, state, or community.

Another aspect of the present invention is to provide a system of assigning and storing a unique identifier to an entity in a database. The system includes a computer system configured to assign the unique identifier to the entity. The unique identifier includes a domain portion defining a jurisdiction of the entity; a sub-domain portion having an entity type, global registration agency code for the jurisdiction, and a date of registration or formation of the entity; a registration identifier portion of the entity in the jurisdiction. The system further includes a database in communication with the computer system configured to store the unique identifier along with a name of the entity in the database for fast retrieval of information about the entity.

In an embodiment, the unique identifier further includes another portion disposed between the domain portion and the sub-domain portion, the other portion further refining the jurisdiction of the entity. In an embodiment, the database is configured to receive a query from a client computer to provide the information about the entity using the unique identifier.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 shows an example of a unique identifier for a juridical person (company) conforming to the requirements for an authoritative legal identifier as defined in the ISO 8000-116 standard, according to an embodiment of the present invention;

FIG. 2 shows an example structure of a unique identifier for a natural person, according to another embodiment of the present invention;

FIG. 3 shows an example structure of unique identifier for a juridical person (company), a domain of the unique identifier including the two-character ISO 3166-1 country code, according to another embodiment of the present invention;

FIG. 4 shows an example structure of a proxy identifier for a natural person, a sub-domain of the proxy identifier indicating the identifier that uses the United States Department of State as the registration agency for the registration identifier portion of the proxy identifier, according to another embodiment of the present invention.

FIG. 5 is a flow diagram of an exemplary method for assigning the unique identifier to an entity, according to an embodiment of the present invention;

FIG. 6 is a schematic diagram of an exemplary system for assigning/storing the unique identifier or identifiers, according to an embodiment of the present invention;

FIG. 7 illustrates an exemplary computer system; and

FIG. 8 depicts a processor system architecture of the unique identifier, according to an embodiment of the present invention.

### DETAILED DESCRIPTION

One aspect of this invention is to provide a method and system for creating a unique and unambiguous identifier for both natural and juridical persons conforming to the ISO 8000-116 standard to act as a master identifier to which all other identifiers for the same natural or juridical person can reference, thus allowing the identifier for a person issued in one jurisdiction to be easily translated into the identifier issued within the same, or by another, jurisdiction for the same person.

Moreover, because conformance to the ISO 8000-116 requires conformance to ISO 8000-115 defining a “quality identifier,” another aspect of the invention is to employ the same method and system for creating a unique and unambiguous identifier for legal entities such as natural and juridical persons for creating unique identifiers for non-legal entities such as products, parts and materials, events, and/or geographic locations.

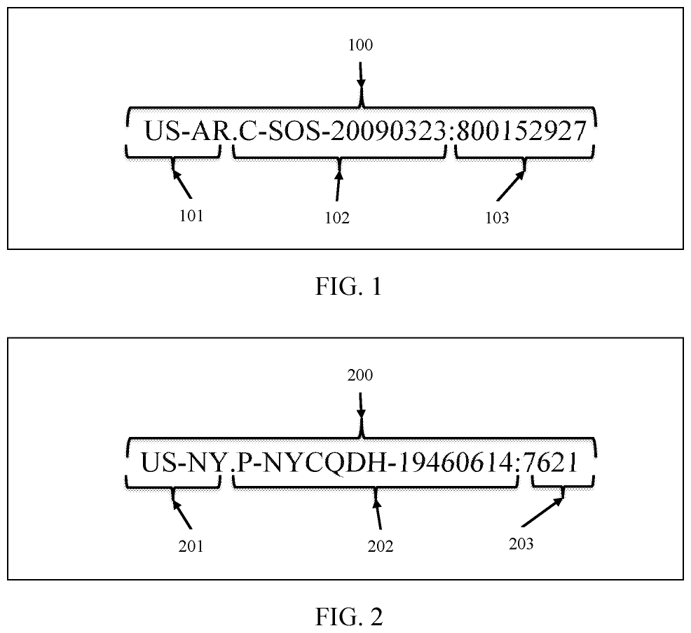

FIG. 1 illustrates an example of a unique identifier 100 for a juridical person (company). The figure shows a template of a unique identifier 100 for identifying an entity using the ISO 8000-116 standard, according to an embodiment of the present invention. The entity can be a natural, judicial, and/or juridical entity. For example, the entity can be a person, a corporation, a partnership, a financial institution, or a market participant. In an embodiment, the unique identifier 100 can include a domain portion 101, referred to as the “domain” in the ISO 8000-116 standard, having a jurisdiction of the entity. The unique identifier can further include a second portion 102, referred to as the “sub-domain” in the ISO 8000-116 standard, having a global registration agency code for the jurisdiction. The unique identifier can also include a third portion 103, referred to as the “registration identifier” in the ISO 8000-116 standard, having a registration identifier of the entity in the jurisdiction.

In accordance with the ISO 8000-116 standard, the domain portion 101 of the unique identifier 100 must be separated from the sub-domain portion 102 of the unique identifier 100 by a period or full-stop character (“.”), and the sub-domain portion 102 of the unique identifier 100 must be separated from the registration identifier portion 103 of the unique identifier 100 by a colon character (“:”). In order to maintain the integrity of this structure, clear distinction between the portions 101, 102 and 103 of the unique identifier 100, the period character (“.”) and the colon character (“:”) must not be used as part of the content of either the domain or sub-domain, but used only to denote the boundaries between the three portions 101, 102 and 103 of the unique identifier 100.

In an embodiment, the domain portion 101 complies with ISO 3166-1 and ISO 3166-2 standards. In an embodiment, the jurisdiction of the entity in the domain portion 101 includes a jurisdiction country (e.g., shown in FIG. 1 as “US” corresponding to the United States of America) of the entity and when applicable, a sub jurisdiction such as a state or region (e.g., shown in FIG. 1 as “AR” corresponding to the state of Arkansas) in the country (e.g., US) of the entity. Although, a specific example is provided in FIG. 1 using the United States of America and the state of Arkansas as the country of jurisdiction and state of jurisdiction of the entity, respectively, any other country and/or state or province can be used. As shown in FIG. 1, the country of jurisdiction is represented by using the ISO 3166-1 code, for example “US” for United States of America. Similarly, as shown in FIG. 1, the sub jurisdiction is represented by using the ISO 3166-2 code, for example “AR” for the state of Arkansas.

ISO 3166-1 is part of the ISO 3166 standard published by the International Organization for Standardization (ISO), and defines codes for the names of countries, dependent territories, and special areas of geographical interest. ISO 3166-2 is also part of the ISO 3166 standard published by the International Organization for Standardization (ISO), and defines codes for identifying the principal subdivisions (e.g., provinces or states) of all countries coded in ISO 3166-1. The purpose of ISO 3166-2 is to establish an international standard of short and unique alphanumeric codes to represent the relevant administrative divisions and dependent territories of all countries in a more convenient and less ambiguous form than their full names. Therefore, the jurisdiction country complies with the ISO 3166-1 standard and the sub jurisdiction state or region or province complies with the ISO 3166-2 standard. When the sub jurisdiction is used, the alphanumeric code for the country of jurisdiction and the alphanumeric code for the state or jurisdiction within the domain portion 102 are separated by a hyphen or “-”.

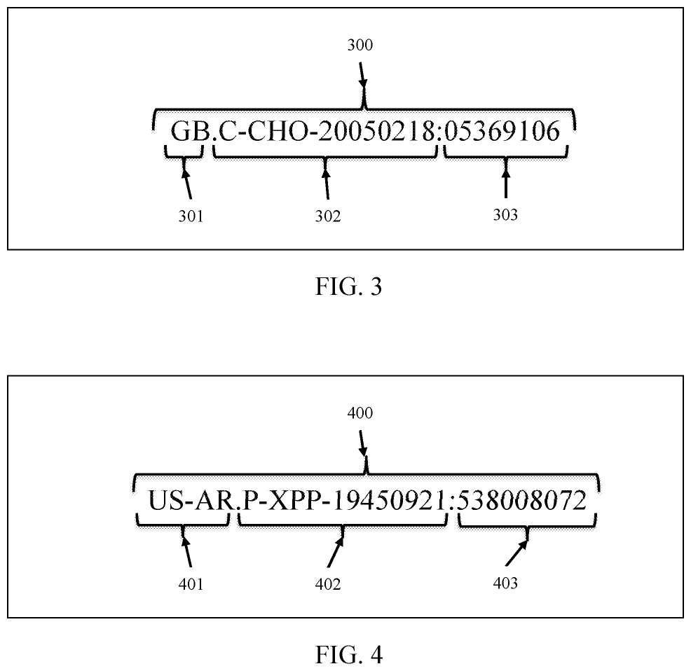

In accordance with the ISO 8000-116 standard, the sub jurisdiction is optional. An example of this is shown in FIG. 3 (described below) where the domain comprises only the country code (“GB”). This is because all companies in Great Britain (“GB”) are registered by the Charter House regardless of the region of Great Britain where the company headquarters is located. However, when both the jurisdiction and sub jurisdiction are present, they must be separated by the hyphen (“-”) character.

In an embodiment, the global registration agency code 102 (e.g., “C-SOS-20090323” in FIG. 1) for the jurisdiction indicated by the domain portion 101 comprises a plurality of characters or numbers, or both. The global registration identifier in the sub-domain portion 102 is specific to the jurisdiction indicated in the domain portion 101. The encoding of the sub-domain portion 102 of the identifier 100 represents one purpose and novelty of an aspect of the present invention. While the ISO 8000-116 standard requires a non-empty, subdomain value to be included, the sub-domain portion 102 does not prescribe a specific format or structure. An embodiment of the present invention defines a method for encoding the sub-domain 102 that provides five distinction and valuable functions:
(1) the sub-domain 102 is encoded in such a way to ensure the totality of the complete identifier comprising the domain, sub-domain, and registration identifier will be globally unique across all domains, entity types, registration agencies, registration dates, and registration identifiers, i.e. the identifier for a legal entity formed by using the method according to an embodiment of this invention will be different from the identifier for any other legal entity formed using the method of this invention,
(2) the sub-domain 102 is encoded to indicate the type of entity represented by the unique identifier (e.g., “C” for company in FIG. 1),
(3) the sub-domain 102 is encoded to indicate the legal authority holding the registration of the entity (e.g., “SOS” for the Office of the Secretary of State in the jurisdiction of Arkansas in FIG. 1),
(4) the sub-domain 102 is encoded to indicate the date upon which the entity was registered by the agency (e.g. Mar. 23, 2009 given in ISO Standard format as “20090323” in FIGS. 1), and
(5) in the case information from the primary legal registration agency (e.g., birth certificate registration for a natural person by a Department of Vital Statistics) is not available, the method according to an embodiment of the present the invention provides a way to encode a globally unique “proxy identifier” based on secondary legal registration agencies (e.g., passport registrations for natural persons) to act as place holder until such time as such registration information becomes available.

In an embodiment, as shown in FIG. 1, the domain portion 101 and the sub-domain portion 102 are separated by a period or full stop character (“.”). The sub-domain portion 102 is also separated into three distinct parts by the hyphen (“-”) characters. The three parts of the sub-domain 102 are the Entity Type (e.g., “C” in FIG. 1), the Registration Authority (e.g., “SOS” in FIG. 1), and the Registration Date (e.g., “20090323” in FIG. 1), respectively. The Entity Type is a combination of one to three consecutive letters and digits indicating the type of entity (person) identified, e.g. “C” in FIG. 1, indicating a company (juridical person). The Registration Authority is a combination of one to thirty-two letters and digits indicating the legal authority with which the entity is registered within the jurisdiction given by the domain, e.g., “SOS” in FIG. 1, indicating the Office of the Secretary of State within the State of Arkansas in the United States of America. The Registration Date is an eight-digit number representing a valid date in ISO 8601 format indicating the date upon which the legal entity was created, e.g., “20090323” in FIG. 1, indicating the formation of the company on Mar. 3, 2009.

In an embodiment, the domain portion 101 and sub-domain portion 102 form a prefix of the unique identifier 100 and the registration identifier portion 103 form a suffix of the unique identifier 100. In an embodiment, the prefix and the suffix of the unique identifier 100 are separated by a colon (“:”) character.

In an embodiment, the unique identifier 100 can be generated in a human readable configuration such as the unique identifier shown in FIG. 1. In another embodiment, the unique identifier 100 can also be converted into a unique hash code, e.g., a GUID (e.g., “0098567a-0d68-4ecb-9a8b-a7b6f66fbb3c”). A GUID (or UUID) is an acronym for ‘Globally Unique Identifier’ (or ‘Universally Unique identifier’). It is a 128-bit integer number used to identify resources. The term GUID is generally used by developers working with MICROSOFT technologies, while UUID is used everywhere else. In an embodiment, where a company or entity has concerns or a policy to employ hashing, the unique identifier can be converted into a unique hash code. For example, this may be the case when the entity is concerned about exposing the date-of-birth for natural person identifier or a passport number used as a proxy identifier.

FIG. 2 shows a structure of a unique identifier 200 for identifying a natural person entity, according to another embodiment of the present invention. The unique identifier 200 is similar in many aspects to the unique identifier 100 shown in FIG. 1. However, in this example the unique identifier 100 and unique identifier 200 are assigned to different entities. For example, the unique identifier 200 can include the domain portion 201 having a jurisdiction of the entity, the sub-domain portion 202 having the entity type, global registration agency code, and registration date, and the registration identifier 203 issued by the legal registration authority.

As shown in FIG. 2, the jurisdiction of the entity in the domain portion 201 includes a jurisdiction country (e.g., US corresponding to United States of America) of the entity and jurisdiction state or region (e.g., NY corresponding to the state of New York) in the country (e.g., US) of the entity. Similar to the embodiment shown in FIG. 1, in FIG. 2, the country of jurisdiction is represented by using the ISO 3166-1 code, for example “US” for United States of America and the state of jurisdiction is represented by using the ISO 3166-2 code, for example “NY” for the state of New York.

In the embodiment shown in FIG. 2, the global registration agency code (e.g., “P-NYCQDH-19460614”) for the jurisdiction in the sub-domain portion 202 includes a plurality of characters or numbers, or both. The global registration agency code (e.g., “P-NYCQDH-19460614”) is unique within the jurisdiction (e.g., “US-NY”) of the entity.

In the embodiment shown in FIG. 2, the domain portion 201 and the sub-domain portion 202 are separated by a period “.”. The registration identifier portion 203 and the sub-domain portion 202 are separated by a colon “:”. The sub-domain portion 202 having the global registration agency code (e.g., “P-NYCQDH-19460614”) for the domain, and the registration identifier portion 203 having an identifier issued by the global registration agency.

In an embodiment, the domain portion 201 and the sub-domain portion 202 together form a prefix of the unique identifier 200, and the registration identifier portion 203 forms a suffix of the unique identifier 200. In an embodiment, the sub-domain portion 202 includes a unique code for a registration authority within any one of a metropolitan area, a county, a city, a borough, or a region (e.g., “QUEENS”) within a jurisdiction country (e.g., “US”) and jurisdiction state (e.g., “NY”) of the entity. In FIG. 2, the code “NYCQDH” represents the Department of Health in the Queens borough of New York City.

Similar to unique identifier 100, the unique identifier 200 can be generated in a human readable configuration such the unique identifier shown in FIG. 2. In another embodiment, the unique identifier 200 can also be converted into a unique hash code, e.g., a GUID (e.g., “0098469a-0d68-4dce-9a8b-a9b6f78fbb4c”).

FIG. 3 shows an example structure of unique identifier for a juridical person (company), a domain of the unique identifier including the two-character ISO 3166-1 country code, according to another embodiment of the present invention. FIG. 3 shows a structure of a unique identifier 300 for identifying an entity, according to another embodiment of the present invention. The unique identifier 300 is similar in many aspects to the unique identifier 100 shown in FIG. 1. However, the unique identifier 100 and unique identifier 300 are assigned to different entities. For example, the unique identifier 300 includes the domain portion 301 having a jurisdiction of the entity, the sub-domain portion 302 having the entity type, global registration agency code, and registration date, and the registration identifier 303 issued by the legal registration authority.

FIG. 4 shows an example structure of a proxy identifier 400 for identifying a natural person entity, according to another embodiment of the present invention. The proxy identifier 400 is similar in many aspects to the unique identifier 200 in FIG. 2. However, the proxy identifier 400 and unique identifier 200 are assigned to different persons in different jurisdictions. More importantly, the two identifiers 200 and 400 are using different registration authorities. The unique identifier 200 is based on a birth certificate issues by the Queens Department of Health in New York City while the proxy identifier 400 is based on a passport issued by the United States Department of State. The birth certificate registration is considered the primary (authoritative registration) of a natural person and the passport registration is secondary. The passport registration is secondary because a birth certificate is required evidence for issuing a passport. The same is true for proxy identifiers based on driver's license registration or other secondary natural person registrations.

For example, the unique identifier 400 includes the domain portion 401 having a jurisdiction of the entity, the sub-domain portion 402 having the entity type, global registration agency code, and registration date, and the registration identifier 403 issued by the legal registration authority. As shown in FIG. 2, the jurisdiction of the entity in the domain portion 401 includes a jurisdiction country (e.g., US corresponding to United States of America) of the entity and jurisdiction state or region (e.g., AR corresponding to the state of Arkansas) in the country (e.g., US) of the entity. Similar to the embodiment shown in FIG. 2, the country of jurisdiction is represented by using the ISO 3166-1 code, for example “US” for United States of America and the state of jurisdiction is represented by using the ISO 3166-2 code, for example “AR” for the state of Arkansas. In the embodiment shown in FIG. 4, the global registration agency code (e.g., “P-XPP-19450921”) for the jurisdiction in the sub-domain portion 402 includes a plurality of characters or numbers, or both. The global registration agency code (e.g., “P-XPP-19450921”) is unique within the jurisdiction (e.g., “US-AR”) of the entity.

The 8000-116 standard leaves the problem of making the identifiers globally unique up to collaborating users of the identifiers. For example, User A and User B can agree on a set of sub-domain codes to make the codes they exchange globally unique for their specific limited context. However, User A might have a different set of sub-domain codes to make the identifiers it exchanges with another User C globally unique. In this scenario, the User A-User B identifier for a legal entity may be different from the identifier for the same legal entity in the User A-User C context. The disclosed system solves this problem by making the identifier identifiers globally unique for all users and regardless of their use in any context.

In the embodiment shown in FIG. 4, the domain portion 401 and the sub-domain portion 402 are separated by a period “.”. The registration identifier portion 403 and the sub-domain portion 402 are separated by a colon “:”. The sub-domain portion 402 having the global registration agency code (e.g., “P-XPP-19450921”) for the domain, and the registration identifier portion 403 having an identifier issued by the global registration agency.

While a proxy identifier is globally unique, it is intended only as a placeholder, a way to reference natural or juridical persons when the primary registration information is not available. At the time primary registration information becomes available for a person, any proxy identifiers for the same person are replaced by the unique identifier based on the primary registration.

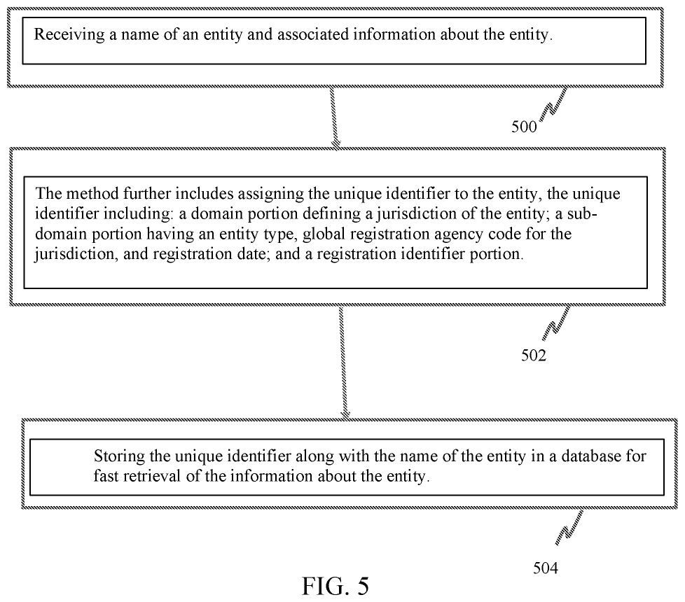

Another aspect of an embodiment of the present invention is to provide a method of assigning the unique identifier 100, 200 to an entity. FIG. 5 is flow diagram of the method for assigning the unique identifier to an entity, according to an embodiment of the present invention. The method includes receiving, at 500, a name of an entity and associated information about the entity. In an embodiment, the name of the entity and the associated information about the entity can be received from a third party database, for example from OPENCORPORATES. OPENCORPORATES is a website which shares data on individual corporate entities under the share-alike attribution Open Database License (ODL). The method further includes assigning, at 502, the unique identifier 100, 200, 330, 400 to the entity, the unique identifier 100, 200, 300, 400 including: a domain portion 101, 201, 301, 401 defining a jurisdiction of the entity; a sub-domain portion 102, 202, 302, 402 having an entity type, global registration agency code for the jurisdiction, and registration date; and a registration identifier portion 103, 203, 303 and 403. The method also includes storing, at 504, the unique identifier 100, 200, 300, 400 along with the name of the entity in a database for fast retrieval of the information about the entity. As it can be appreciated, the one-to-one relationship between the unique identifier 100, 200, 300, 400 and the entity can be implemented for one or a plurality of entities. For example, entity A can be assigned identifier ID-A, entity B can be assigned identifier ID-B, entity C can be assigned unique identifier ID-C, etc. The identifiers ID-A, ID-B and ID-C are different so as to distinguish between the various entities A, B and C. In practice, there are thousands of entities and each entity has an assigned unique identifier. In this way, by assigning a unique identifier to each entity in the plurality of entities (thousands or more entities), it possible, for example, to retrieve information about any entity in the plurality of entities without ambiguity.

In an embodiment, a software program can be used to harvest or retrieve the name of the entity and associated information from the third party database (e.g., OPENCORPORATES) and assign the unique identifier to the entity. The software program is called OYSTER (Open sYSTem Entity Resolution). This software program is an entity resolution system that supports probabilistic direct matching, transitive linking, and asserted linking. To facilitate prospecting for match candidates (blocking), the system builds and maintains an in-memory index of attribute values to identities. Because OYSTER has an identity management system, it also supports persistent unique identity identifiers. OYSTER is unique among other systems in that it is built to incorporate Entity Identity Information Management (EIIM). OYSTER supports EIIM by providing methods that enforce that the identifiers are unique among identities, maintain persistent IDs over the life of an identity. OYSTER also provides the ability to adjudicate false-positive and false-negative resolutions, which cannot be done with matching rules, through the use of assertion, trace-ability, and other features.

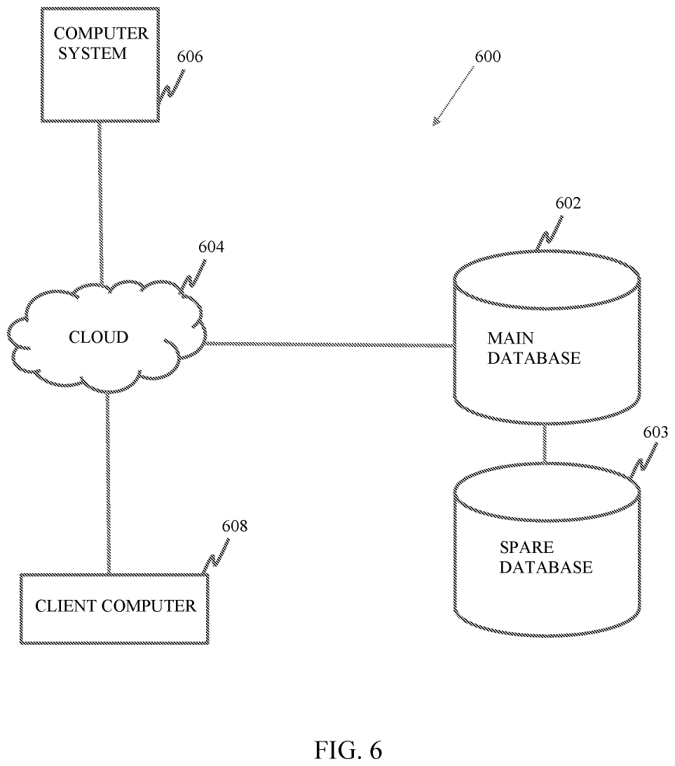

FIG. 6 is a schematic diagram of a system 600 for assigning/storing the unique identifier or identifiers, according to an embodiment of the present invention. In an embodiment, a database 602 is provided for storing the unique identifier 100, 200, 300, 400 and associated name of the entity and entity information can be hosted in a server computer or a network attached storage (NAS). Although as described the unique identifier 100, 200, 300, 400 and associated name of entity and entity information are stored in the same database 602, the unique identifier 100, 200, 300, 400 and associated name of entity and entity information can also be stored in different databases. In an embodiment, the database 602 can be hosted in the “cloud” 604 via a web-service such as Amazon Web Services (AWS), Azure, or any other web-service provider. The database 602 is managed via computer system 606. For example, a new record for a new entity can be added or an existing record updated or deleted by using the computer system 606. The database 602 can also be accessed using a client computer 608 by sending instructions to the database 602 to read, retrieve information about records from the database 602. The computer system 606 and/or the client computer 608 can be a desktop computer, a laptop computer, a handheld computing device such as a PDA, a smart phone, a tablet, etc. The computer system 606 can also be a server-type computer.

The database 602 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Standard Query Language), NoSQL, a SAN (storage area network), Microsoft Access™, Databricks, or others may also be used, incorporated, or accessed. The database 602 may comprise one or more such databases that reside in one or more physical devices and in one or more physical locations. The database 602 may store a plurality of types of data and/or files and associated data or file descriptions, administrative information, or any other data. Data redundancy can be provided such that data stored in the database 602 is mirrored in one or more spare databases 603.

In an embodiment, a query may be sent by the client computer 608 to the database 602 hosted in the “cloud” 604. The database 602 is configured to receive the query from the client computer 608 to provide information about the entity (e.g., name of the entity and other data pertaining to the entity) using the unique identifier 100, 200, 300, 400. The query can take the following form “Whois US-AR.C-SOS-20090323:800152927.” That is, the query can take the form of “whois” followed by the unique identifier 100, for example. In return, the client computer 608 then receives a data response from the database 602 including the name of the entity associated with the unique identifier “US-AR.C-SOS-20090323:800152927” and information about the entity. For example, the data can take the following form shown in TABLE 1 which include various information about the entity as well as the name of the entity. The system can also support database queries in both file or batch modes, as well as employ a single transaction mode which leverages various Application Program Interface (API) endpoints. In addition, the system can support external queries via the API endpoints.

TABLE 1

| | |
|---|---|
| Entity Name | ABCD CORP. |
| Fictitious Names | PRIVACYSTAR |
| Filing Number | 800152927 |
| Filing Type | Foreign For Profit Corporation |
| Filing under Act | For Bus Corp; 958 of 1987 |
| Status | Good Standing |
| Principal Address | |
| Reg. Agent | JOHN DOE |
| Agent address | 123 Way Street, Suite 123, Little Rock, AR 72000 |
| Date filed | Mar. 23, 2009 |
| Officers | JANE DOE |
| Foreign Name | N/A |
| Foreign Address | 1111 Main St., Conway, AR 72000 |
| State of Origin | DE |

The above described unique identifier and method and system of assigning/storing the unique identifier can be applied in various fields including, but not limited to, legal entity ownership, industrial sectors, financial sector, news., social media, financial data, government, and open data.

In the event that a query results in no matches, the system can offer near matches or other close records as part of a returned response array. For example, consider a user using the system to identify which entity produced is responsible for a given item using only the identifier. The user may enter the identifier into the query field of the system, and in this case the system will determine that no perfect match for the domain portion having a jurisdiction of the entity, the sub-domain portion having the entity type, global registration agency code, and registration date, and the registration identifier. However, the system can compare the individual portions of the identifier against other valid identifiers, and provide those similar results to the user. For example, if the sub-domain portion and the registration identifier matched one or more other known identifiers, but the country code did not match, that information could be useful to the user, who may have obtained an incorrect domain/country code for the identifier. In verifying the existence of the other identifiers, the system can transmit, in parallel, queries to the respective registration agencies or entities, thereby verifying that the list of known identifiers with similar identifiers are valid. The list can then be provided to the user.

As it can be appreciated from the above paragraphs, the present identifier and system provides a customized, robust parsing of, for example, company names (including domestic and international) to determine matches. In an embodiment, the present identifier and system leverages probabilistic logic and various normalization routines of the input data to facilitate matching and/or linking of records. In addition, the use of a multi-source set of data repositories, each with its own set of unique identifiers, can be assigned a universal identifier which can be used to access data across the multiple sources (if it is stored by data owners). The universal identifier can also be used to facilitate direct communication between the multiple sources using their existing internal/native identifiers by letting the universal identifier (the present identifier described herein) act as a “linking identifier” to facilitate cross referencing. Furthermore, in an embodiment, the present identifier can be a self-defining identifier that contains deterministic subsets of information such as country, entity type, legal registration identifier, etc. In an embodiment, the present identifier and supporting data augmentation logic provides a complete “view” of the corporate entity and details in a unified view versus currently siloed and hard to access data stores. In an embodiment, the present identifier can be a managed identifier that auto correlates based upon any additional information it is presented. For example, the present identifier can consider and handle mergers, acquisition, etc. based upon data the identifier receives.

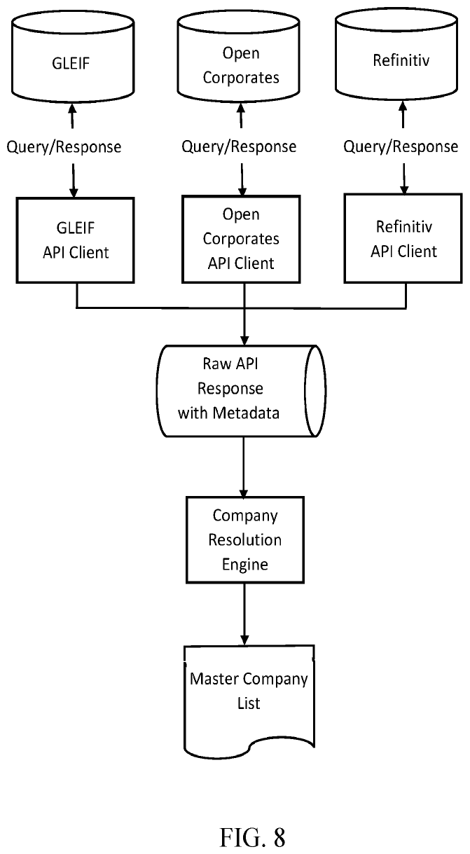

FIG. 8 depicts a processor system architecture of the unique identifier, according to an embodiment of the present invention. In an embodiment, the system architecture includes a set of sourcing services or application programming interfaces (APIs) to authenticate, query, extract and load data from several external authoritative sources, into a staging database that stores raw reference data from each source. The external authoritative sources include, but not limited to, Open Corporates, Refinitiv, Global Legal Entity Identifier Foundation (GLEIF), or any other source depending on type of information data needed. The processor system architecture also includes a company resolution engine (CRE) that produces master records for each company (Master Company List) by resolving differences between reference source data, and a set of services that validate identifier structure and content. In an embodiment, validations are performed by the CRE by comparing the identifier against the defined structure through the use of tools such as regular expressions, validating values in the domain against predefined jurisdictions, validating the sub-domain against predefined valid values for entity types, registration agency codes for the jurisdiction, validating that the date component is a valid date and where possible checking the identifier for a given global registration agency is valid. In an embodiment, validations can be performed by comparing the identifier against a defined format and structure through the use of software techniques such as regular expressions and by comparing the data elements and identifiers against a set of authoritative and trusted data sources which allows for: a) validating values in the domain against predefined jurisdictions, b) validating the sub-domain against predefined valid values for entity types, c) validating registration agency codes for the jurisdiction, d) validating that the date component is a valid date, and/or e) checking the identifier for a given global registration agency is valid.

In an embodiment, the CRE can use distributed processing technologies to quickly compare resolve legal entities. In distributed processing systems, multiple central processing units work on the same program, function or system to provide more capability for a computer system to speed up the computing process. For example, in the present case, the resolution of legal entities can be run through the multiple central processing units wherein each central processing unit would be programmed to read from an assigned database of identifiers to compare the desired identifier against the defined structure and retrieve the associated entity information. In an embodiment, blocking and indexing approaches are used to accelerate processing speed and reduce the number of potential comparisons needed for a given resolution. For example, a given input record is only compared against other records that have a predefined potential to refer to the same legal entity. For example, the given input record is compared to similar records or records that have a common geographical area (e.g., country, state, etc.) or having a same type or function (e.g., records associated with passport numbers in a certain country, records associated with vehicle registration numbers, etc.). Comparison leverage both deterministic and probabilistic algorithms and techniques that allow for both exact and approximate matching to be utilized in determining if records refer to the same entity. This enables the CRE to increase its efficiency by quickly resolving legal entities across multiple repositories. After records are compared and resolved to legal entities, the CRE applies identifiers described in embodiments of this invention and generates appropriate metadata about each legal entity back to the source of the data. Additional metadata includes timestamps and traceable information to describe how the records were matched ad resolved internally in the system such as the criteria and comparative thresholds for various elements that constituted two given records refer to the same legal entity. An API is provided as a software intermediary to send or receive a query to each of the external authoritative sources (e.g., GLEIF, Open Corporates, Refinitiv, etc.). A raw API response which may include metadata is then provided to the CRE which produces the Master Company List. Examples of metadata that may be included are the source, timestamp of submission, response time, age, match status (e.g., resolved or not found) and confidence score of the information contained in the API response, etc.

Consider the following example. An entity (such as a business, an individual, a non-profit, a government agency, etc.) is establishing a new identifier for an item . For example, the identifier could be associated with items such as a new product, a new regulation or policy, a new authorization, etc. The entity defines that item with descriptive metadata, and submits the item description to the system. The system then generates a globally unique identification code for the item in the manner described herein. Specifically, the system can use the country code, the entity identification code, and/or other factors to generate the domain portion for the identifier (identifying a jurisdiction of the entity). The system can also generate the sub-domain portion, which can have aspects such as the entity type, global registration agency code, and registration date. The generation of the sub-domain portion can, in some configurations, be performed using the CRE which can use the raw API responses with metadata received from various databases to uniquely identify a given entity and generate the appropriate subdomain. Finally, the system can generate the registration identifier issued by the legal registration authority. To ensure that the registration identifier being generated has not been previously issued by the legal registration authority, the system can electronically communicate with the one or more computer databases via the APIs and verify that the new registration identifier has not already been assigned. In instances where a given entity is releasing multiple items from disparate locations on a single day, electronic communications between the legal registration authority and the disparate locations may be necessary to ensure the uniqueness of a given registration identifier.

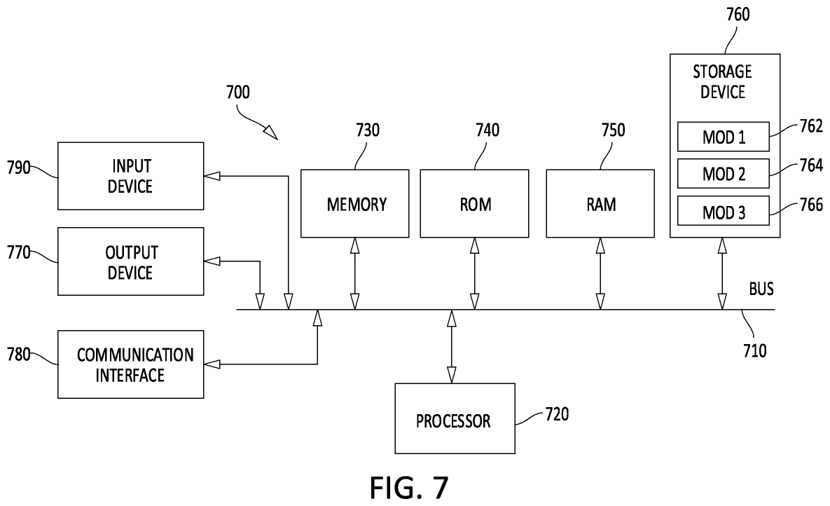

With reference to FIG. 7, an exemplary system includes a general-purpose computing device 700, including a processing unit (CPU or processor) 720 and a system bus 710 that couples various system components including the system memory 730 such as read-only memory (ROM) 740 and random access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as Solid State Drives (SSDs), magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method of assigning a unique identifier to an entity, comprising:
receiving a name of the entity and associated information about the entity;
assigning the unique identifier to the entity, the unique identifier comprising:
a domain portion defining a jurisdiction of the entity;
a sub-domain portion having an entity type, global registration agency code for said jurisdiction, and a date of registration or formation of the entity;
a registration identifier portion of said entity in said jurisdiction; and
storing said unique identifier along with the name of said entity in a database for fast retrieval of information about said entity.

2. The method according to claim 1, wherein said domain portion complies with ISO 3166-1 and ISO 3166-2 standards.

3. The method according to claim 1, wherein said jurisdiction of the entity comprises a jurisdiction country of said entity and jurisdiction state or region in the jurisdiction country of said entity.

4. The method according to claim 3, wherein said jurisdiction country complies with ISO 3166-1 standard and said jurisdiction state or region complies with ISO 3166-2 standard.

5. The method according to claim 1, wherein the registration identifier portion for said jurisdiction comprises a plurality of characters or numbers, or both.

6. The method according to claim 1, wherein the registration identifier portion comprises a plurality of characters or numbers, or both.

7. The method according to claim 1, wherein the domain portion and the sub-domain portion are separated by a period (“.”), the sub-domain portion and the registration identifier portion are separated by a colon (“:”).

8. The method according to claim 1, wherein the domain portion and sub-domain portion form a prefix of the unique identifier, and the registration identifier portion forms a suffix of the unique identifier.

9. The method according to claim 8, wherein the prefix and the suffix of the unique identifier are separated by a colon (“:”) character.

10. The method according to claim 1, wherein said unique identifier is convertible into a unique hash code.

11. The method according to claim 1, wherein said unique identifier complies with ISO 8000-116 standard when the entity is a legal entity and has been granted legal status by a governing body of a nation, state, or community.

12. The method according to claim 11, wherein the unique identifier further includes another portion including any one of a metropolitan area, a county, a city, a borough, or a region within a jurisdiction country of the entity.

13. A unique identifier for identifying an entity, comprising:
a domain portion defining a jurisdiction of the entity;
a sub-domain portion having an entity type, global registration agency code for said jurisdiction, and a date of registration or formation of the entity; and
a registration identifier portion of said entity in said jurisdiction,
wherein said unique identifier along with a name of said entity are stored in a database for fast retrieval of information about said entity.

14. The unique identifier according to claim 13, wherein said domain portion complies with ISO 3166-1 and ISO 3166-2 standards.

15. The unique identifier according to claim 13, wherein said jurisdiction of the entity comprises a jurisdiction country of said entity and jurisdiction state or region in the jurisdiction country of said entity.

16. The unique identifier according to claim 15, wherein said jurisdiction country complies with ISO 3166-1 certification and said jurisdiction state or region complies with ISO 3166-2 certification.

17. The unique identifier according to claim 13, wherein the entity type comprises a plurality of characters or numbers, or both.

18. The unique identifier according to claim 13, wherein the sub-domain portion comprises a plurality of characters or numbers, or both, and said sub-domain portion is unique within the domain portion.

19. The unique identifier according to claim 13, wherein the domain portion and the sub-domain portion are separated by a period (“.”), and the sub-domain portion and the registration identifier portion are separated by a colon (“:”).

20. The unique identifier according to claim 13, wherein the domain portion and sub-domain portion form a prefix of the unique identifier, and the registration identifier portion forms a suffix of the unique identifier.

21. The unique identifier according to claim 13, wherein said unique identifier is convertible into a unique hash code.

22. The unique identifier according to claim 13, wherein said unique identifier complies with ISO 8000-116 standard when the entity is a legal entity and has been granted legal status by a governing body of a nation, state, or community.

23. A system of assigning and storing a unique identifier to an entity in a database, comprising:
A computer system configured to assign the unique identifier to the entity, the unique identifier comprising:
a domain portion defining a jurisdiction of the entity;
a sub-domain portion having an entity type, global registration agency code for said jurisdiction, and a date of registration (formation) of the entity;
a registration identifier portion of said entity in said jurisdiction; and
a database in communication with the computer system configured to store said unique identifier along with a name of said entity in the database for fast retrieval of information about said entity.

24. The system according to claim 23, wherein the unique identifier further includes another portion disposed between the domain portion and the sub-domain portion, said another portion further refining the jurisdiction of the entity.

25. The system according to claim 23, wherein said database is configured to receive a query from a client computer to provide the information about the entity using said unique identifier.
